(19) United States
(12) Patent Application Publication
(10) Pub. No.: US 2006/0145478 A1
(43) Pub. Date: Jul. 6, 2006

(54) Hose coupling device

(76) Inventor: Wen Kuei Hwang, Taichung (TW)

Correspondence Address: Wen Kuei Hwang, P.O. Box 63-298, Taichung, 40699, TW

(21) Appl. No.: 11/025,720

(22) Filed: Dec. 30, 2004

(51) Int. Cl. F16L 33/18

(52) U.S. Cl. 285/353; 285/342; 285/250

(57) ABSTRACT

A hose coupling device includes a connector having one or more ports each having an enlarged outer duct and an inclined segment disposed between the duct and the port. One or more gaskets are disposed in the port and engaged with an inclined surface of the duct, a ferrule includes a threaded end for threading with the duct, and for forcing the gasket between the connector and the ferrule and the hose. The ferrule includes an inclined surface, a latch member is disposed in the ferrule, and engaged between the gasket and the ferrule, and includes an inclined surface for engaging with the inclined surface of the ferrule, and thus to solidly secure the ferrule and the hose together.

### BACKGROUND OF THE INVENTION

1. Field of the Invention

The present invention relates to a hose coupling device, and more particularly to a hose coupling device having a quick and flexible coupling structure.

2. Description of the Prior Art

Various kinds of typical hose coupling devices have been developed and comprise a connector for coupling two or more pipes or hoses together.

For example, U.S. Pat. No. 3,711,131 to Evans discloses one of the typical hose end couplings including a tubular nipple or insert piece which is inserted in a bore of a hose, and the nipple is formed with exterior circumferential ribs or teeth to aid in proper connection with the hose. Normally, a lock nut or a tubular ferrule is further provided and threaded to the insert, to secure and couple the hose to the insert piece. However, the hose may not be firmly secured between the insert piece and the lock nut or the tubular ferrule, and may have a good chance to be disengaged from the insert piece and the lock nut or the tubular ferrule.

U.S. Pat. No. 4,366,841 to Currie et al. and U.S. Pat. No. 4,407,532 to Patel et al. disclose two other typical compensating hose fittings each also including an insert having a number of axially spaced annular barbs extended therefrom, for engaging with a hose, and a socket having annular projections extended therefrom for engaging with the hose, and thus for attaching or securing the hose to the insert. However, similarly, the socket may not be firmly attached to the insert, such that the hose may not be solidly secured and coupled to the insert, and such that the hose also may have a good chance to be disengaged or removed from the insert and the socket.

U.S. Pat. No. 4,640,211 to Namur discloses a further typical adjustment fixture hose construction including a cylindrical intermediate member and a separate O-ring to be engaged or attached between an outer main tube and an end tube. However, the cylindrical intermediate member and the O-ring are simply force-fitted between the outer main tube and the end tube, and also may have a good chance to be disengaged or removed from the outer main tube and the end tube.

U.S. Pat. No. 4,690,435 to Manning et al. discloses a still further typical hose coupling including a hose to be engaged between an inner sleeve and an outer sleeve. The inner sleeve includes an annular radially extending projection lock bead or flange extended therefrom, for engaging with the hose, and for securing the hose between the inner and the outer sleeves. The outer sleeve includes a number of annular radially extending reduced diameter crimp sections for engaging with the hose. However, similarly, the hose may not be firmly or solidly retained or secured between the inner and the outer sleeves, and may have a good chance to be disengaged or removed from the inner and the outer sleeves.

The present invention has arisen to mitigate and/or obviate the afore-described disadvantages of the conventional hose coupling device devices.

### SUMMARY OF THE INVENTION

The primary objective of the present invention is to provide a hose coupling device including a quick and flexible coupling structure for allowing pipes or hoses to be easily and readily and quickly coupled together.

In accordance with one aspect of the invention, there is provided a hose coupling device comprising a connector including a first port having an enlarged outer duct provided thereon, the duct including an outer diameter greater than that of the first port, and an inclined segment provided between the duct and the first port, to form an inclined surface in the first port, and an inner thread provided in the duct, at least one gasket disposed in the first port and engaged with the inclined surface of the duct of the first port, a ferrule including a threaded end formed thereon, for threading with the inner thread of the duct of the connector, and for threadedly securing the ferrule to the first port of the connector, the ferrule being engageable with the gasket, to force the gasket between the connector and the ferrule and the hose, to make a water tight seal between the connector and the ferrule and the hose, the ferrule including an inclined surface formed therein, a hose engageable into the ferrule, and a latch member disposed and received in the ferrule, and including a first end having an inclined surface formed thereon for engaging with the inclined surface of the ferrule, and including a second end, and the latch member may be forced to be solidly engaged between the hose and the ferrule with an engagement between the inclined surfaces of the ferrule and of the latch member, to further solidly secure or lock the hose to the connector, and to prevent the hose from being disengaged from the connector.

A second gasket may further be provided and disposed in the first port and engaged between the gasket and the ferrule. The latch member included a peripheral rib extended from either or both of the ends of the hose, for solidly engaging with the hose, and for facilitating a gripping or grasping or holding of the latch member with the hose.

The connector further includes at least one second port provided thereon, at least one second gasket disposed in the first port and engaged with the inclined surface of the duct of the first port, a second ferrule having a threaded end for threading with the second port of the connector, a second hose is engageable into the second ferrule, the second ferrule is engageable with the second gasket, to force the second gasket between the connector and the second ferrule and the second hose, a second latch member is disposed and received in the second ferrule and engaged between the second gasket and the second ferrule, and includes an inclined surface formed therein, for engaging with the inclined surface of the second ferrule.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a hose coupling device in accordance with the present invention;

FIG. 2 is an enlarged partial plan view of the hose coupling device, in which one half of the hose coupling device is cut off to show an inner structure of the hose coupling device;

FIG. 3 is an enlarged partial cross sectional view of the hose coupling device,

FIG. 4 is an exploded view similar to FIG. 1, illustrating the other arrangement of the hose coupling device;

FIG. 5 is an enlarged partial plan view of the hose coupling device as shown in FIG. 4, in which one half of the hose coupling device is also cut off to show an inner structure of the hose coupling device;

FIG. 6 is an exploded view similar to FIGS. 1 and 4, illustrating another arrangement of the hose coupling device;

FIG. 7 is an exploded view similar to FIGS. 1, 4 and 6, illustrating a further arrangement of the hose coupling device; and

FIG. 8 is an exploded view similar to FIGS. 1, 4, 6, and 7, illustrating a still further arrangement of the hose coupling device.

### DETAILED DESCRIPTION OF THE PREFERRED EMBODIMENT

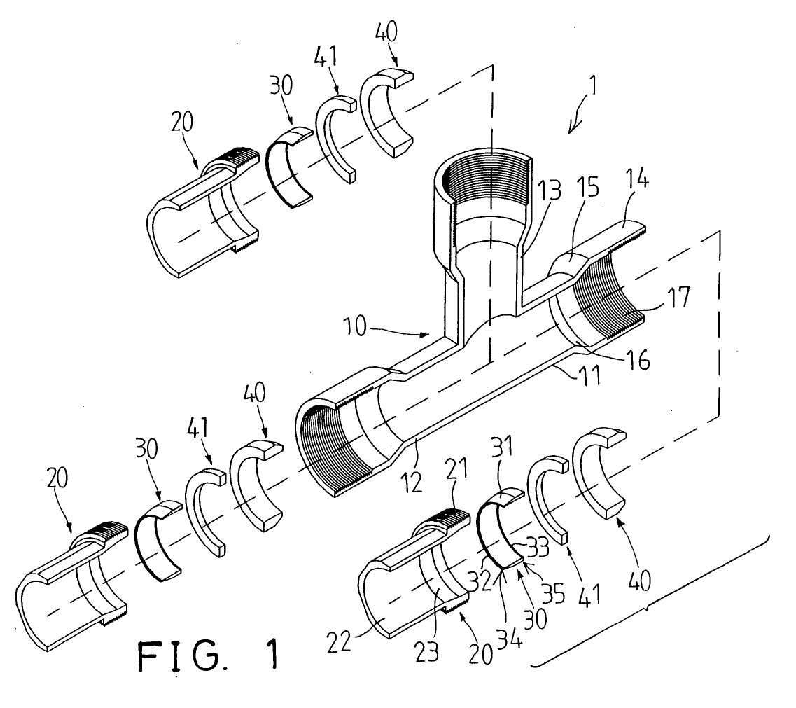

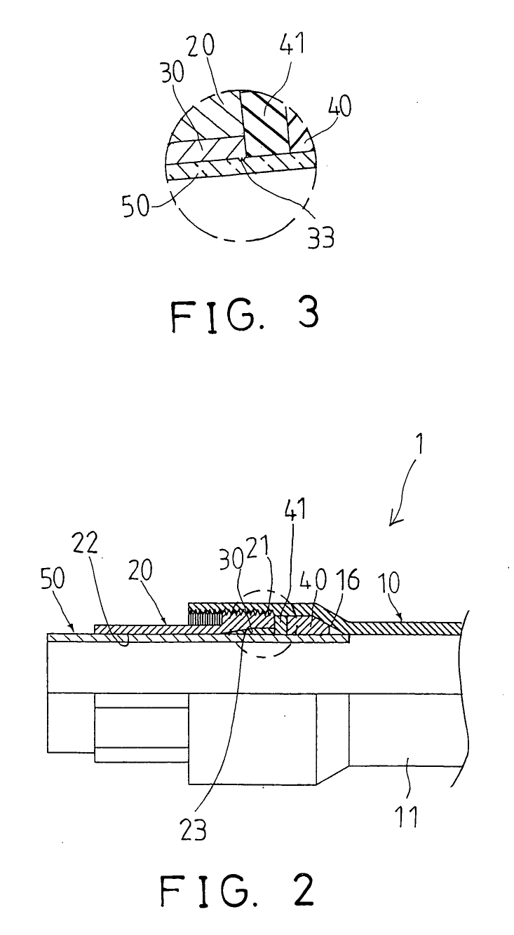

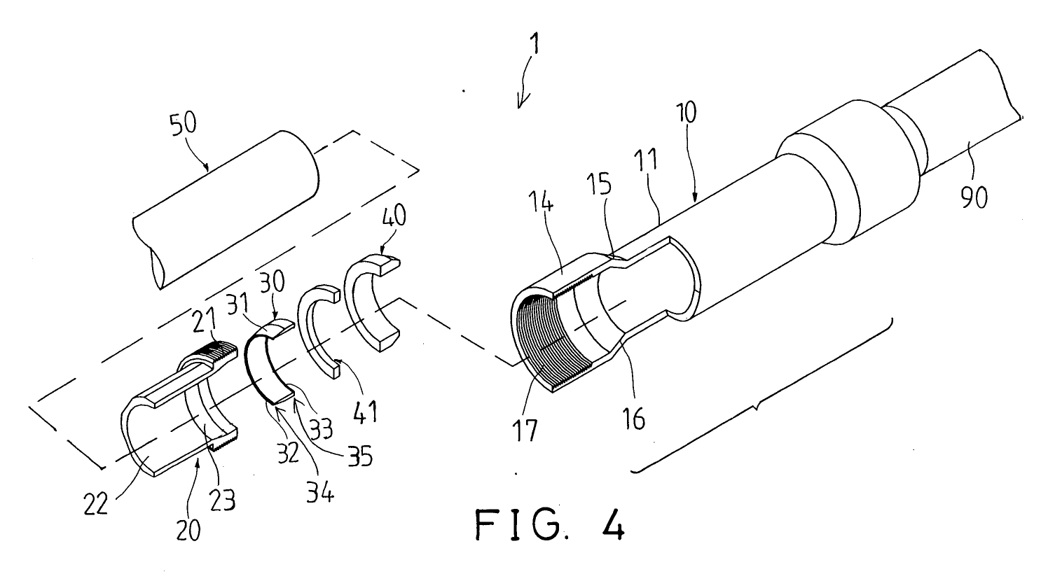

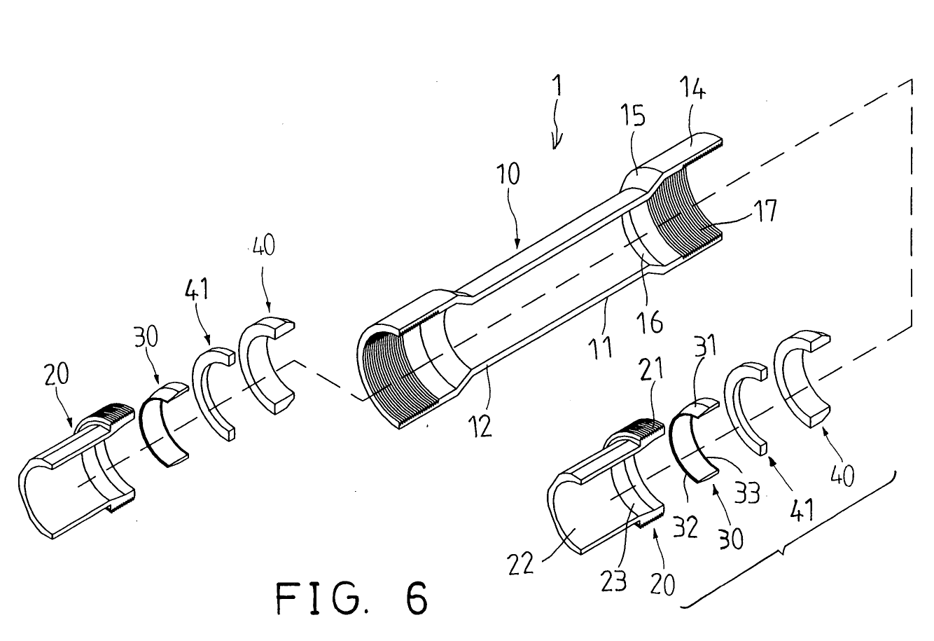

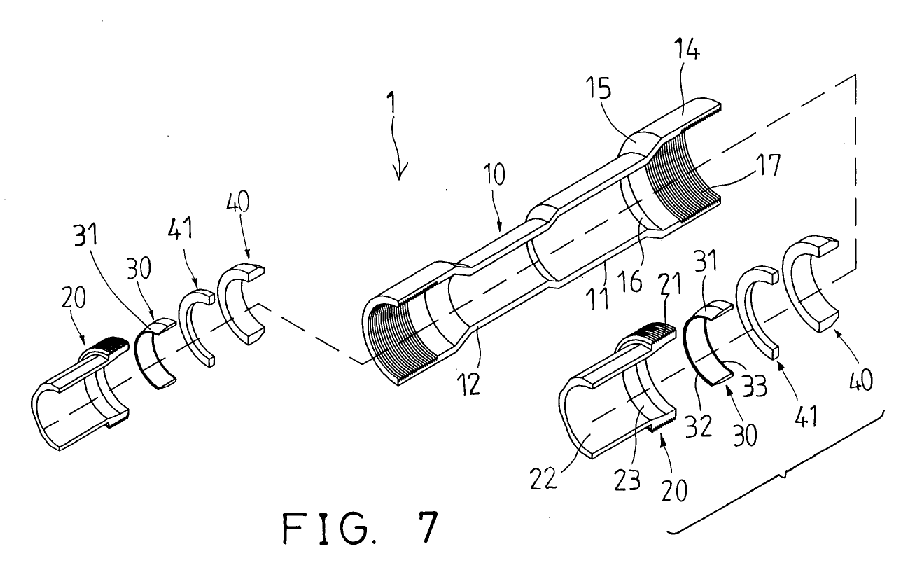

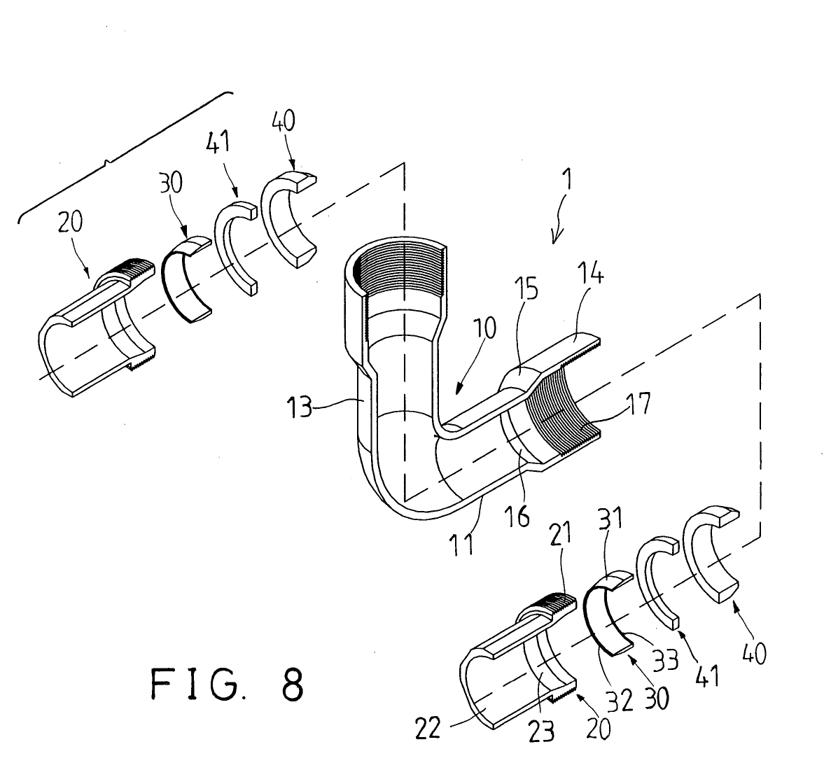

Referring to the drawings, and initially to FIGS. 1 and 2, a hose coupling device 1 in accordance with the present invention comprises a connector 10 including one or more ports 11, 12, 13 provided or formed therein, such as including a T-shape having three ports 11, 12, 13 (FIG. 1) provided therein, an I-shape having two ports 11, 12 (FIGS. 6, 7) provided therein and/or having different outer diameters, an L-shape having two ports 11, 13 (FIG. 8) provided therein, or including an I-shape having one port 11 (FIGS. 3, 4) provided therein and having a pipe 90 coupled thereto (FIGS. 3, 4).

The connector 10 includes an enlarged duct 14 formed or provided on an outer portion of each of the ports 11, 12, 13, and having an outer diameter greater than that of the ports 11, 12, 13 respectively, and having an inclined segment 15 formed or provided between the duct 14 and the ports 11, 12, 13 respectively, in order to form or define an inclined or conical surface 16 in such as the inclined segment 15, and to provide an inner thread 17 within the duct 14.

The connector 10 further includes a ferrule 20 having an outer thread 21 formed or provided on one end thereof, for threading with the inner thread 17 of the duct 14 of the connector 10, and thus for threadedly or adjustably securing the ferrule 20 to either of the ports 11, 12, 13 of the connector 10 (FIGS. 2, 4). The ferrule 20 includes a bore 22 formed therein for receiving a hose 50 that is to be coupled to the connector 10, in which the hose 50 may also be extended or engaged into the connector 10 (FIGS. 2, 4). The ferrule 20 further includes an inclined surface 23 formed therein.

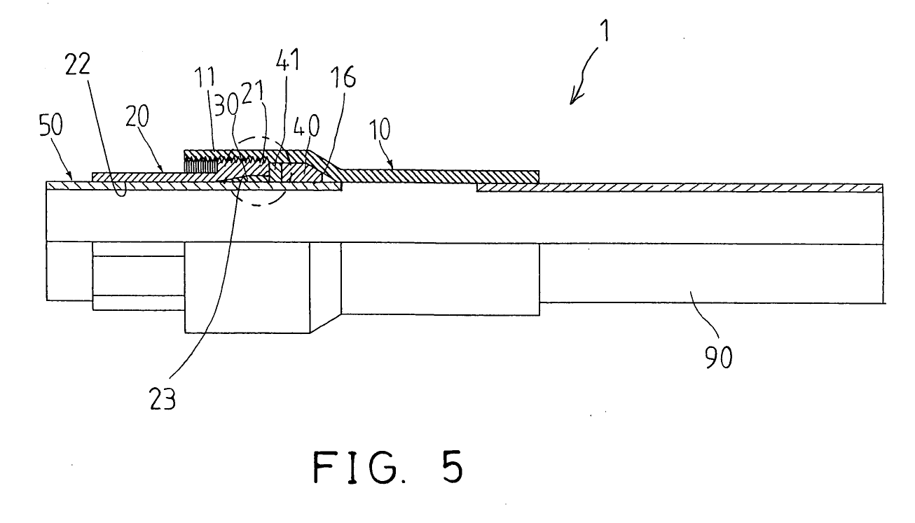

The connector 10 further includes a wedge or latch member 30 disposed or received in the bore 22 of the ferrule 20, and having an inclined surface 31 formed on one end 34 thereof, for engaging with the inclined surface 23 of the ferrule 20. It is preferable that the latch member 30 further includes one or more, such as two peripheral ribs 32, 33 formed or extended from inner portions of two ends 34, 35 thereof, for engaging with the hose 50 (FIGS. 2, 3, 5), and for facilitating a gripping or grasping of the latch member 30 to the hose 50, and for preventing the latch member 30 from slipping relative to the hose 50.

The connector 10 further includes a resilient or flexible or soft gasket 40 disposed or received in the port 11 and engaged with the inclined surface 16 of the duct 14 or of the port 11, and another resilient or flexible or soft gasket 41 disposed or received in the port 11 and engaged between the gasket 40 and the other end 35 of the latch member 30 and the ferrule 20.

In operation, as shown in FIGS. 1-3, the gaskets 40, 41 may be disposed or received in the port 11 of the connector 10, and may be engaged with the inclined surface 16 of the duct 14 or of the port 11. The threaded end or the outer thread 21 of the ferrule 20 may then be threaded with the inner thread 17 of the duct 14 of the connector 10, and may solidly force or squeeze the gaskets 40, 41 between the ferrule 20 and the connector 10 and the hose 50, in order to make a water tight seal between the port 11 of the connector 10 and the hose 50.

In addition, the inclined surface 31 of the latch member 30 may further be engaged with the inclined surface 23 of the ferrule 20, and may thus be engaged between the ferrule 20 and the hose 50, (FIGS. 2, 4-5), such that the latch member 30 may be wedged and solidly engaged between the inclined surface 23 of the ferrule 20 and the hose 50, and may thus be used to solidly anchor or to secure or to latch the ferrule 20 and the hose 50 together. It is to be noted that the latch member 30 may further be solidly engaged between the ferrule 20 and the hose 50 due to the inclined surfaces 23, 31 of the ferrule 20 and the latch member 30, when the ferrule 20 is further rotated or threaded with the duct 14 of the connector 10.

Similarly, the other ports 12, 13 of the connector 10 each may also include two gaskets 40, 41 disposed or received in the port 11 of the connector 10, and a latch member 30 engaged onto a hose 50, and a ferrule 20 also engaged onto the hose 50 and engaged onto the latch member 30, and then threaded with the port 11, to solidly couple and secure the hose 50 to the port 11 of the connector 10.

Accordingly, the hose coupling device in accordance with the present invention includes a quick and flexible coupling structure for allowing pipes or hoses to be easily and readily and quickly coupled together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A hose coupling device comprising:
a connector including a first port having an enlarged outer duct provided thereon, said duct including an outer diameter greater than that of said first port, and an inclined segment provided between said duct and said first port, to form an inclined surface in said first port, and an inner thread provided in said duct,
at least one gasket disposed in said first port and engaged with said inclined surface of said duct of said first port,
a ferrule including a threaded end formed thereon, for threading with said inner thread of said duct of said connector, and for threadedly securing said ferrule to said first port of said connector, said ferrule being engageable with said at least one gasket, to force said at least one gasket between said connector and said ferrule and said hose, to make a water tight seal between said connector and said ferrule and said hose, said ferrule including an inclined surface formed therein,
a hose engageable into said ferrule, and
a latch member disposed and received in said ferrule, and including a first end having an inclined surface formed thereon for engaging with said inclined surface of said ferrule, and including a second end, and said latch member being forced to be solidly engaged between said hose and said ferrule with an engagement between said inclined surfaces of said ferrule and of said latch member.

2. The hose coupling device as claimed in claim 1 further comprising a second gasket disposed in said first port and engaged between said at least one gasket and said ferrule.

3. The hose coupling device as claimed in claim 1, wherein said latch member included a peripheral rib extended from said first end thereof, for engaging with said hose.

4. The hose coupling device as claimed in claim 1, wherein said latch member included a peripheral rib extended from said second end thereof, for engaging with said hose.

5. The hose coupling device as claimed in claim 1, wherein said connector further includes at least one second port provided thereon, at least one second gasket disposed in said first port and engaged with said inclined surface of said duct of said first port, a second ferrule having a threaded end for threading with said at least one second port of said connector, a second hose is engageable into said second ferrule, said second ferrule is engageable with said at least one second gasket, to force said at least one second gasket between said connector and said second ferrule and said second hose, a second latch member is disposed and received in said second ferrule and engaged between said at least one second gasket and said second ferrule, and includes an inclined surface formed therein, for engaging with said inclined surface of said second ferrule.
